(19) United States
(12) Patent Application Publication
(10) Pub. No.: US 2024/0100952 A1
(43) Pub. Date: Mar. 28, 2024

(54) DEVICE AND METHOD FOR INTERLOCKING DISPLAY DEVICE

(71) Applicant: HYUNDAI MOBIS CO., LTD., Seoul (KR)

(72) Inventors: Shin Jik LEE, Hwaseong-si (KR); Sung Joon AHN, Gwangmyeong-si (KR); Ji Soo SHIN, Yongin-si (KR); Jun LEE, Yongin-si (KR); Hyun Jun AN, Gunpo-si (KR); Seung Ho SONG, Yongin-si (KR)

(73) Assignee: HYUNDAI MOBIS CO., LTD., Seoul (KR)

(21) Appl. No.: 18/368,540

(22) Filed: Sep. 14, 2023

(30) Foreign Application Priority Data
Sep. 27, 2022 (KR) 10-2022-0122470

(51) Int. Cl. B60K 37/04

(52) U.S. Cl. CPC B60K 37/04; B60K 2370/40; B60K 2370/67; B60K 2370/682; B60K 2370/816; B60K 2370/834

(57) ABSTRACT

Disclosed herein is a device for interlocking a display device with a vehicle, the device including a mount disposed in the vehicle, the display device being attached to and detached from the mount, a first sliding member disposed on a front surface of the mount and capable of moving forward or backward in a direction perpendicular to a rear surface of the display device, and a connector provided to the first sliding member, wherein the connector may transmit and receive electrical signals to and from the display device. The vehicle may be controlled by coupling a display device to the interlocking device disposed in the vehicle. Even when the display device is not coupled to the vehicle, the vehicle may be controlled by pairing through wireless communication between the vehicle and the display device.

This application claims the benefit of Korean Patent Application No. 10-2022-0122470, filed on Sep. 27, 2022, which is hereby incorporated by reference as if fully set forth herein.

### BACKGROUND OF THE DISCLOSURE

### Technical Field

The present disclosure relates to an interlocking device and method for interlocking a vehicle with a display device, and is applicable to vehicles in any field, and more specifically, for example, to vehicles that support autonomous driving.

### Background

Autonomous driving is a growing area of research that allows vehicles to move without human intervention. Autonomous driving devices are broadly classified into five generations, and research is currently being conducted on third-generation autonomous driving devices, which are capable of changing lanes through partial autonomous driving, fourth-generation autonomous driving devices, which are capable of autonomously driving to a destination by coping with external dangers caused by the driving environment through semi-autonomous driving, and fifth-generation autonomous driving devices, which are capable of autonomous driving on all routes through full autonomous driving without user intervention.

As autonomous driving technology becomes more advanced and popular, there is a growing need for display devices to be used inside vehicles, and it is necessary to interlock display devices with vehicles to allow vehicles to be controlled through display devices from any place inside the vehicle.

### SUMMARY

An object of the present disclosure is to provide a device and method for interlocking a vehicle and a display device, and more particularly to provide a display device interlocking device and method for controlling a vehicle by coupling a display device to an interlocking device disposed on the vehicle.

An object of the present disclosure is to provide a display device interlocking device and method for controlling a vehicle through pairing between the vehicle and the display device even when the display device is not coupled to the vehicle.

The objects of the present disclosure are not limited to the above-mentioned technical objects, and other technical objects not mentioned above will become apparent to one of ordinary skill in the art from the following description.

To achieve these objects and other advantages and in accordance with the purpose of the disclosure, as embodied and broadly described herein, a device for interlocking a display device with a vehicle may include a mount disposed in the vehicle, the display device being attached to and detached from the mount, a first sliding member disposed on a front surface of the mount and capable of moving forward or backward in a direction perpendicular to a rear surface of the display device, and a connector provided to the first sliding member, wherein the connector may transmit and receive electrical signals to and from the display device.

The display device may include a display module disposed on a front surface thereof and configured to output an image, and a linkage disposed on a rear surface of the display module and connected to the connector.

The connector may include a FAKRA connector.

The mount may include a second sliding member disposed to move the first sliding member.

The first sliding member and the second sliding member may include racks arranged on lateral surfaces thereof, and a pinion engaged with the racks to move the first sliding member and the second sliding member in opposite directions.

The second sliding member may include a first elastic member arranged to exert an elastic force when the display device is attached to and detached from the mount.

The display device may include a coupling part disposed on a rear surface thereof, wherein the coupling part may include a first fastener having a first engagement protrusion, wherein the first fastener may include a second fastener disposed on a side of the second sliding member and having a second engagement protrusion.

The first fastener may include a seating groove, the second engagement protrusion being seated in the seating groove.

The coupling part seating groove may include a rotating arm configured to move the first fastener in a horizontal direction parallel to the rear surface of the display device.

The coupling part may include a third sliding member disposed to move in a vertical direction parallel to the rear surface of the display device, wherein the third sliding member may be coupled to the rotating arm to rotate the rotating arm.

The first fastener may include a second elastic member arranged to exert an elastic force upon rotation of the rotating arm.

The third sliding member may include a handle protruding toward the rear surface of the display device, wherein the coupling part further may include a handle hole formed to expose the handle to and outside and secure a movement region for the handle.

The mount may include a first switch disposed in a movement region of the first sliding member, and a second switch disposed in a movement region of the second sliding member, wherein the first switch and the second switch may detect whether the display device is attached to or detached from the mount.

The mount may include a tilting part arranged to rotate the mount about an axis line oriented in a horizontal direction.

The mount may include a sliding cover arranged to open and close a front of the mount.

In another aspect of the present disclosure, a method of interlocking a display device with a vehicle may include determining whether the display device is attached to or detached from a display device interlocking device disposed in the vehicle, determining an interlocking state of the display device, and controlling the vehicle based on the determination of whether the display device is attached or detached and the interlocking state of the display device.

The determining of the interlocking state of the display device may include determining, when the display device is coupled to the display device interlocking device, whether the display device is interlocked with a processor of the vehicle.

The determining of the interlocking state of the display device may include determining, when the display device is detached from the display device interlocking device, whether the display device is interlocked with a processor of the vehicle.

The method may further include performing pairing through wireless communication between the vehicle and the display device.

The determining of the interlocking state of the display device may include outputting the interlocking state to an output module of the vehicle or an output module of the display device.

According to the above-described embodiments of the present disclosure, a display device interlocking device and method may control a vehicle by coupling a display device to an interlocking device disposed on the vehicle.

Further, according to embodiments of the disclosure as described above, a vehicle may be controlled by pairing through wireless communication between a vehicle and a display device even when the display device is not coupled to the vehicle.

The effects obtainable from the present disclosure are not limited to those mentioned above, and other effects not mentioned above will be apparent to one having ordinary skill in the art from the following description.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a system block diagram of a vehicle and a display device according to one embodiment of the present disclosure;

FIG. 2 is a view illustrating the display device positioned in the vehicle according to one embodiment of the present disclosure;

FIG. 3(a) and FIG. 3(b) are a view of the display device interlocking device according to one embodiment of the present disclosure;

FIG. 4 is a top view of a mount for the display device interlocking device according to one embodiment of the present disclosure;

FIG. 5 is an exploded view of the display device on the display device interlocking device according to one embodiment of the present disclosure;

FIG. 6 is a top view of the coupling structure of a coupling part and a mount in the display device interlocking device according to one embodiment of the present disclosure;

FIG. 7(a) and FIG. 7(b) are a view illustrating the operation of attaching and detaching the coupling part and the mount in the display device interlocking device according to one embodiment of the present disclosure;

FIG. 8 is a view illustrating the coupling part in the display device interlocking device according to one embodiment of the present disclosure;

FIG. 9(a) and FIG. 9(b) are a view illustrating another embodiment in which the mount and the coupling part are attached and detached in the display device interlocking device of the present disclosure;

FIG. 10(a) and FIG. 10(b) are a view illustrating a tilting part and a sliding cover in the display device interlocking device according to one embodiment of the present disclosure;

FIG. 11 is a diagram illustrating the display device interlocking method according to one embodiment of the present disclosure; and

FIG. 12 is a diagram illustrating a display device interlocking method according to another embodiment of the present disclosure.

### DETAILED DESCRIPTION

Hereinafter, embodiments disclosed herein will be described in detail with reference to the accompanying drawings. Wherever possible, the same reference numbers will be used throughout the drawings to refer to the same or like parts, and redundant descriptions thereof will be omitted. The suffixes “module” and “unit” of elements herein are used for convenience of description and thus are used interchangeably and do not have any distinguishable meanings or functions. Further, in describing the embodiments disclosed in this specification, if a detailed description of related known techniques would unnecessarily obscure the gist of the embodiments disclosed in this specification, detailed description thereof will be omitted. In addition, the attached drawings are provided for easy understanding of the embodiments disclosed in this specification and do not limit technical idea disclosed in this specification, and the embodiments should be construed as including all modifications, equivalents, and alternatives falling within the spirit and scope of the present disclosure.

Terms containing ordinal numbers, such as first and second may be used to describe various components, but the components are not limited by such terms. These terms are used only to distinguish one component from another.

When a component is described as being “connected” or “linked” to another component, it should be understood that it may be directly connected or linked to the other component, but there may be other components in between. On the other hand, when a component is described as being “directly connected” or “linked” to another component, it should be understood that there is no other component in between.

As used herein, the singular forms “a”, “an”, and “the” include plural referents unless context clearly dictates otherwise.

In this specification, terms such as “includes” or “has” are intended to specify the presence of the features, numbers, steps, operations, components, parts, or combinations thereof disclosed in the specification, and are not to be understood as precluding the possibility of the presence or addition of one or more other features, numbers, steps, operations, components, parts, or combinations thereof.

Also, as used in the following description, “vehicle” assumes a vehicle used to transport passengers, but does not need to be limited to such vehicles. It can include urban air mobility (UAM) and buses.

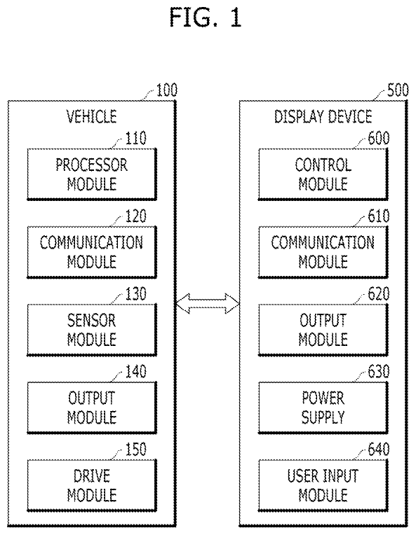

FIG. 1 is a system block diagram of a vehicle and a display device according to one embodiment of the present disclosure.

In some embodiments of the present disclosure, the vehicle 100 may include a processor module 110, a communication module 120, an output module 130, a sensor module 140, and a drive module 150.

The sensor module 140 may include at least one sensor capable of recognizing conditions inside and/or outside the vehicle 100. The sensor module 140 may include, for example, a camera sensor, an infrared sensor, a radar sensor, a voice sensor, a temperature sensor, and a humidity sensor.

The output module 130 may include at least one interface to provide a user of the vehicle 100 with various audiovisual data or information related or unrelated to the vehicle 100, and/or control tools for the vehicle 100 or component(s) thereof. The output module 130 may include, for example, a console display(s) provided for the occupant(s), and/or an acoustic device(s) provided for the occupant(s). The output module 130 may exchange signals with at least one electronic device in the vehicle 100 in a wired or wireless manner. The output module 130 may convert an input by the user of the vehicle 100 into an electrical signal and provide the signal to the processor module 110.

The drive module 150 may physically drive and/or operate internal or external components of the vehicle 100 based on the control of the processor module 110. The drive module 150 may change, for example, the physical position(s) of the wheel(s), steering wheel(s), seat(s), console display(s) of the vehicle 100.

The processor module 110 may include at least one processor. The at least one processor in the processor module 110 may be electrically connected to components (e.g., sensor modules, sensor modules, communication module) of the vehicle 100 to exchange signals and to control the components of the vehicle 100. The processor module 110 may further include at least one memory (not shown). The at least one processor may be referred to as a controller, microcontroller, microprocessor, or microcomputer. The at least one processor may be implemented by hardware, firmware, software, or a combination thereof. For example, the at least one processor may include one or more application specific integrated circuits (ASICs), one or more digital signal processors (DSPs), one or more digital signal processing devices (DSPDs), one or more programmable logic devices (PLDs), or one or more field programmable gate arrays (FPGAs).

The functions, procedures, proposals, and/or methods disclosed herein may be implemented using firmware or software, and the firmware or software may be implemented to include modules, procedures, and functions. Firmware or software configured to perform the functions, procedures, proposals, and/or methods disclosed herein may be included in at least one processor, or may be stored in at least one memory and executed by at least one processor.

The features, procedures, proposals, and/or methods disclosed herein may be implemented using firmware or software in the form of code, instructions, and/or a set of instructions.

The processor module 110 may generate control signals for the sensor module 140, the output module 130, and/or the drive module 150 based on electrical signals received from the sensor module 140 and/or the output module 130.

The at least one memory may be connected to the at least one processor and may store various kinds of information related to the operation of the at least one processor. For example, the at least one memory may store software code that includes instructions for performing some or all of the processes controlled by the at least one processor, or for performing the procedures and/or methods described/proposed below.

The at least one memory may store commands, instructions, or programs, which, when executed, may cause the at least one processor operably connected to the at least one memory to perform operations according to some embodiments of the present disclosure.

The vehicle 100 may include the communication module 120. The communication module 120 may include one or more transceivers, and may receive user data, control information, wireless signals/channels, etc. referred to in the functions, procedures, proposals, methods, and/or flowcharts of operation disclosed herein from one or more other devices via the one or more transceivers.

For example, the one or more transceivers may be connected to the processor module 110, and may transmit and/or receive wireless signals. For example, the at least one processor in the processor module 110 may control the one or more transceivers to transmit user data, control information, or wireless signals to the at least one other device.

Further, the processor module 110 may control the one or more transceivers to receive user data, control information, or wireless signals from one or more other devices. Further, the one or more transceivers may be connected to one or more antennas. The one or more transceivers may be configured to transmit and/or receive user data, control information, wireless signals/channels, etc. to and/or from the other device(s) through the one or more antennas.

In some embodiments of the present disclosure, the display device 500 may include a control module 600, a communication module 610, an output module 620, a power supply 630, and a user input module 640.

The control module 600 may include at least one processor, which may be used to control the overall operation of the display device 500. The processor may be a typical processor, such as a central processing unit (CPU). Of course, the processor may be a dedicated device, such as an ASIC, or a processor based on other hardware.

The communication module 610 may include a wireless communication module for short-range wireless communication with the vehicle 100 according to one embodiment of the present disclosure. Through such a wireless communication module, data may be communicated with an external device.

Thus, by pairing the vehicle 100 and the display device 500 via the wireless communication module, the vehicle 100 may be controlled through the display device 500 from within the vehicle 100 according to one embodiment of the present disclosure.

The output module 620 may include a display to output a screen and an audio output module to output a sound. Thus, in accordance with one embodiment of the present disclosure, whether the vehicle 100 and the display device 500 are paired may be output through the output module 620 of the display device 500. An external device interface 171 may receive device information, executed application information, application images, and the like from a mobile terminal in a mirroring mode.

The power supply 630 may provide power throughout the display device 500. In particular, it may provide power to the control module 600, which may be implemented in the form of a System On Chip (SOC), the display that outputs images, and the audio output module that outputs sound. Specifically, the power supply 630 may include a converter (not shown) configured to convert an alternating current power into a direct current power, and a DC/DC converter (not shown) configured to convert the level of the direct current power.

Also, the power supply 630 receives power from an external source and serves to distribute the power to the respective components. The power supply 630 may be connected directly to the external power source to supply alternating current power, or may include a power supply 630 including a battery that can be charged for use.

In the former case, the power supply is connected to a wired cable and is difficult to move or has a limited range of movement. In the latter case, the power supply is free to move, but it adds as much weight as the battery, is bulky, and needs to be directly connected to a power cable for a certain period of time for charging, or combined with a charging station (not shown) that supplies power.

The charging station may be connected to the display device 500 via an externally exposed terminal, or the embedded battery may be charged by proximity using a wireless method.

In particular, when the vehicle 100 and the display device 500 are paired via the wireless communication module according to one embodiment of the present disclosure, the device may be charged using the wireless charging method described above or its own battery.

The user input module 640 may receive information input from a user of the display device 500. The user input module 640 may include a touch key, a mechanical key, or the like. Once information is entered via the user input module 640, the control module 600 may control the operation of the display device 500 in response to the input information. The user input module 640 may include mechanical input means (or, mechanical keys, e.g., a button, a dome switch, a jog wheel, a jog switch, or the like positioned on the front, back, or side of the display device 500) and tactile input means. In one example, the tactile input means may include a virtual key, soft key, or visual key displayed on a touchscreen through software processing, or a touch key disposed on a part other than the touchscreen. The virtual key or visual key may be displayed on the touchscreen in various forms, for example, as a graphic, text, icon, video, or a combination thereof.

Thus, when the vehicle 100 and the display device 500 are paired according to one embodiment of the present disclosure, the vehicle 100 may be controlled based on information input from the user via the user input module 640 of the display device 500.

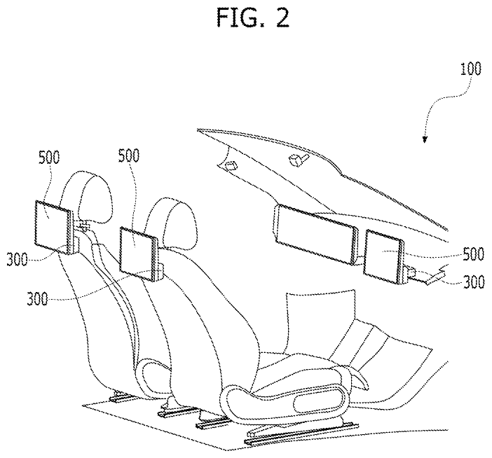

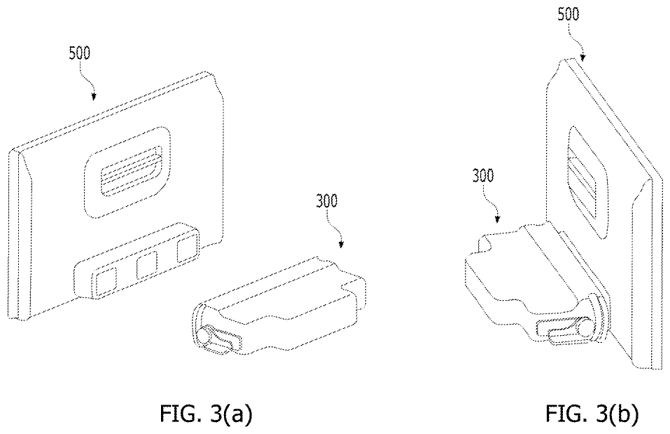

FIG. 2 is a view illustrating the display device positioned in the vehicle according to one embodiment of the present disclosure. FIG. 3(a) and FIG. 3(b) are a view of the display device interlocking device according to one embodiment of the present disclosure.

Referring to FIGS. 2 and 3(a), 3(b), according to one embodiment of the present disclosure, the display device interlocking device 300 may be placed near a front passenger seat or on the back of a seat headrest and coupled with the display device 500.

However, the display device interlocking device 300 is not limited to the positions shown in FIG. 2. The display device interlocking device 300 may be placed at any position within the vehicle 100 so as to be coupled with the display device 500.

Additionally, the vehicle 100 and the display device 500 may be paired even when the display device 500 is detached and not coupled to the display device interlocking device 300. This allows for control of the vehicle 100 via the display device 500 from any location within the vehicle 100.

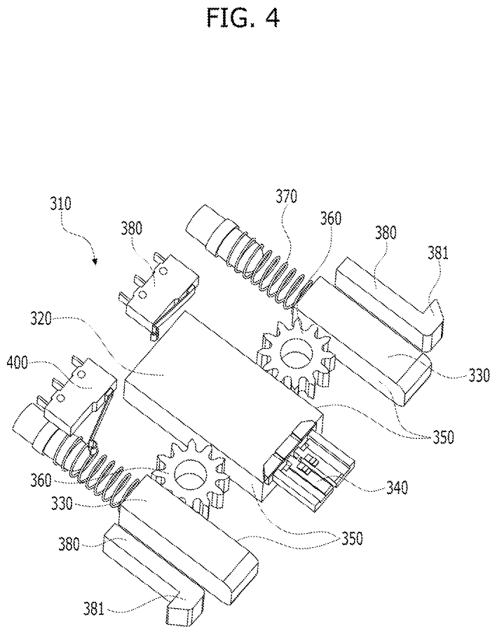

FIG. 4 is a top view of a mount for the display device interlocking device according to one embodiment of the present disclosure.

In the display device interlocking device 300 of the present disclosure, the mount 310 disposed on the vehicle 100 to which the display device 500 is detachably attached may include a first sliding member 320, a second sliding member 330, a connector 340, a rack 350, a pinion 360, a first elastic member 370, a second fastener 380, a second engagement protrusion 381, a first switch 390, and a second switch 400.

The first sliding member 320 is positioned at the front of the mount 310 and may move forward or backward in a direction perpendicular to the rear surface of the display device 500. The first sliding member 320 may include a connector 340.

Here, the connector 340 may be provided to the first sliding member 320 to transmit and receive electrical signals when the display device 500 and the display device interlocking device 300 are coupled. The connector 340 may include a FAKRA connector. The FAKRA connector is a type of connector that is applied to the ends of cables connecting complex parts within the vehicle 100 to facilitate the electrical connection of different cables.

According to one embodiment of the present disclosure, when the display device 500 and the display device interlocking device 300 are coupled, the connector 340 may be coupled with the linkage 530 of the display device 500 to allow control of the vehicle 100 through the display device 500.

The second sliding member 330 may serve to move the first sliding member 320 forward or backward in a direction perpendicular to the rear surface of the display device 500. The first sliding member 320 and the second sliding member 330 may include a rack 350 provided on the lateral surfaces thereof, and a pinion 360 that engages with the rack 350 to move the first sliding member 320 and the second sliding member 330 in opposite directions.

The first elastic member 370 provided to the second sliding member 330 may serve to apply an elastic force to the second sliding member 330 when the display device 500 is attached to or detached from the mount 310.

Thus, when the display device 500 is coupled to the mount 310, the display device 500 pushes the second sliding member 330 in a direction perpendicular to the rear surface of the display device 500, and the pinion 360 is rotationally driven to push the first sliding member 320 toward the display device 500 in a direction opposite to the direction of movement of the second sliding member 330.

Further, in separating the display device 500 from the mount 310, the second sliding member 330 may be moved toward the display device 500 by the elastic force of the first elastic member 370, and the pinion 360 may be rotationally driven to separate the first sliding member 320 from the display device 500.

Additionally, the second fastener 380 may be positioned on a lateral side of the second sliding member 330 and may include a second engagement protrusion 381. Further, the first switch 390 may be disposed in a movement region of the first sliding member 320, and the second switch 400 may be disposed in a movement region of the second sliding member 330. Here, the first switch 390 and the second switch 400 may serve to detect whether the display device 500 and the mount 310 are attached or detached.

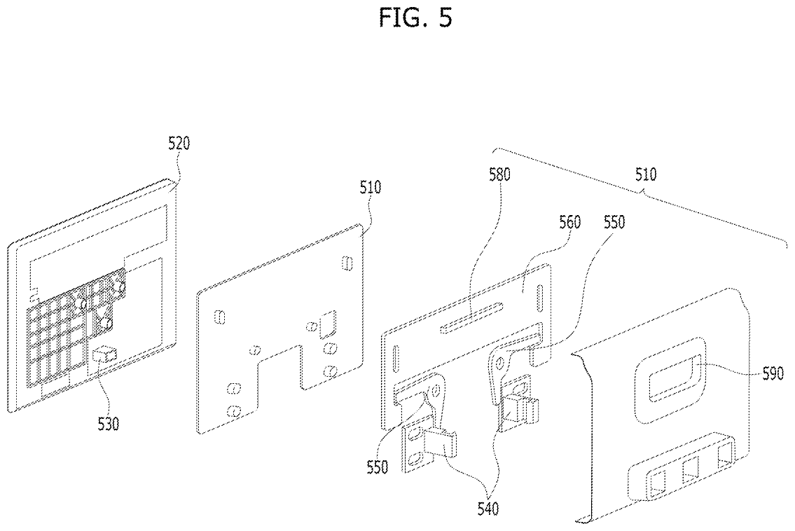

FIG. 5 is an exploded view of the display device on the display device interlocking device according to one embodiment of the present disclosure.

The display device 500 of the present disclosure may include a display module 520 provided on a front surface to output an image, a support panel 151 disposed on a rear surface of the display module 520 and coupled to a coupling part 510, and the coupling part 510 disposed on the rear surface of the support panel. The display module 520 can be implemented to include a display surface such as an electroluminescent, backlit, organic, embedded or other self-illuminated display such as an LED, OLED, LCD or other active display system, screen, panel or material in which the output is incorporated in the display surface

Additionally, the display device 500 may include a linkage 530 disposed on a rear surface of the display module 520 and connected to the connector 340. As the connector 340 is coupled to the linkage 530, electrical signals may be transmitted and received between the vehicle 100 and the display device 500 to control the vehicle 100 through the display device 500.

The coupling part 510 may include a first fastener 540, a first engagement projection 541, a seating groove 543, a rotating arm 550, a third sliding member 560, a second elastic member 570, a handle 580, and a hole in the handle 580.

The first engagement protrusion 541 may be provided on the first fastener 540 and may be engaged with the second engagement protrusion 381 of the second fastener 380. In this case, the second engagement protrusion 381 may be seated in the seating groove 543 of the first fastener 540.

The rotating arm 550 may serve to move the first fastener 540 in a horizontal direction parallel to the rear surface of the display device 500. The rotating arm 550 may be coupled with the third sliding member 560, which moves in a vertical direction parallel to the rear surface of the display device 500, and may rotate upon movement of the third sliding member 560 in the vertical direction. Further, the second elastic member 570 may serve to apply an elastic force to the first fastener 540 upon rotation of the rotating arm 550.

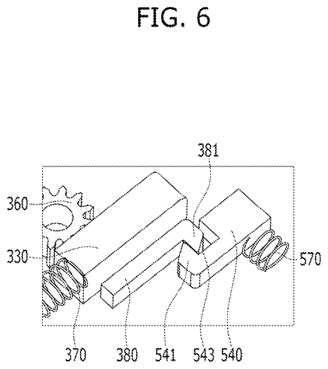

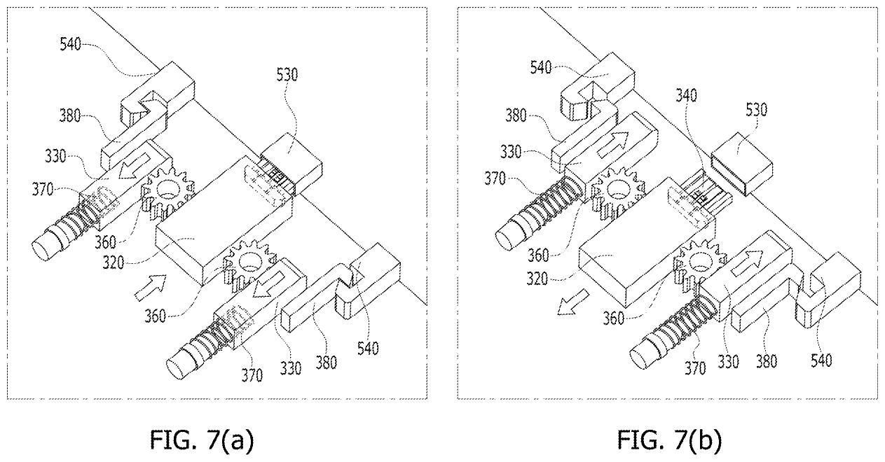

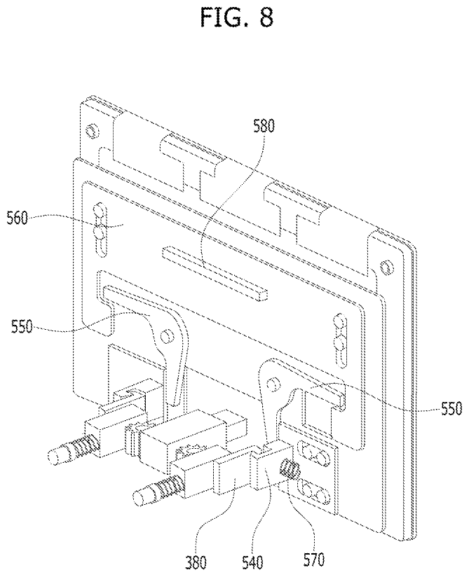

FIG. 6 is a top view of the coupling structure of a coupling part and a mount in the display device interlocking device according to one embodiment of the present disclosure. FIG. 7(a) and FIG. 7(b) are a view illustrating the operation of attaching and detaching the coupling part and the mount in the display device interlocking device according to one embodiment of the present disclosure. FIG. 8 is a view illustrating the coupling part in the display device interlocking device according to one embodiment of the present disclosure.

In the display device interlocking device 300 according to one embodiment of the present disclosure, when the display device 500 is coupled to the mount 310, the display device 500 pushes the second sliding member 330 in a direction perpendicular to the rear surface of the display device 500, and the pinion 360 is rotationally driven to push the first sliding member 320 toward the display device 500 in a direction opposite to the direction of movement of the second sliding member 330.

Also, in detaching the display device 500 from the mount 310, the second sliding member 330 may be moved toward the display device 500 by the elastic force of the first elastic member 370, and the pinion 360 may be rotationally driven to detach the first sliding member 320 from the display device 500.

The procedure for detaching the display device 500 from the mount 310 will be described in more detail below. First, the handle 580 protruding from the third sliding member 560 toward the rear surface of the display device 500 is moved upwardly in a direction parallel to the rear surface of the display device 500. As the third sliding member 560 moves, the third sliding member 560 rotates the rotating arm 550 to move the first fastener 540 in a horizontal direction parallel to the rear surface of the display device 500. As the first fastener 540 moves, it is disengaged from the second fastener 380, and the second sliding member 330 is moved by the first elastic member 370 in a direction perpendicular to the rear surface of the display device 500. The movement of the second sliding member 330 causes the pinion 360 to be rotationally driven to move the first sliding member 320 perpendicularly from the rear surface of the display device 500 in a direction opposite to the direction of movement of the second sliding member 330, and the connector 340 of the first sliding member 320 and the linkage 530 are separated.

Additionally, the third sliding member 560 may have a handle hole 590 that exposes the handle 590 to the outside and secures a movement area for the handle 590.

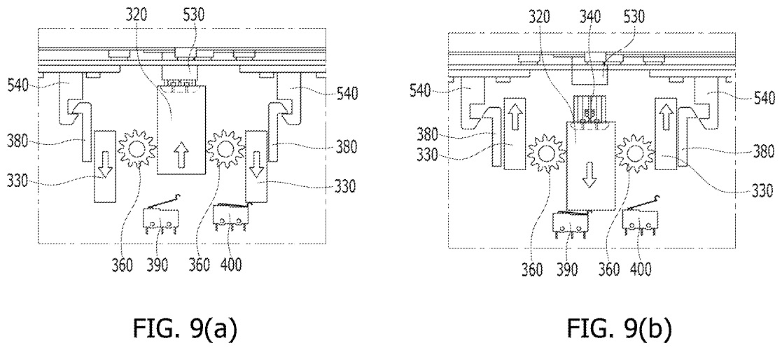

FIG. 9(a) and FIG. 9(b) are a view illustrating another embodiment in which the mount and the coupling part are attached and detached in the display device interlocking device of the present disclosure.

As described above, the display device interlocking device 300 and the display device 500 may be detached and attached by driving of the first sliding member 320, the second sliding member 330, the third sliding member 560, the first fastener 540, the second fastener 380, the first elastic member 370, the second elastic member 570, the rotating arm 550, the rack 350, and the pinion 360 in the display device interlocking device 300 according to one embodiment of the present disclosure.

In this case, the mount 310 of the present disclosure may include a first switch 390 disposed in a movement region of the first sliding member 320 and a second switch 400 disposed in a movement region of the second sliding member 330. Here, the first switch 390 and the second switch 400 may include a limit switch.

When the display device 500 is coupled to the mount 310, the first sliding member 320 may be disconnected from the first switch 390 and the second sliding member 330 may press the second switch 400 to detect that the display device 500 is in a coupled state. When the display device 500 is detached from the mount 310, the second sliding member 330 may be disconnected from the second switch 400 and the first sliding member 320 may press the first switch 390 to detect that the display device 500 is in a detached state. In other words, the first switch 390 and the second switch 400 may detect whether the display device 500 and the mount 310 are attached or detached.

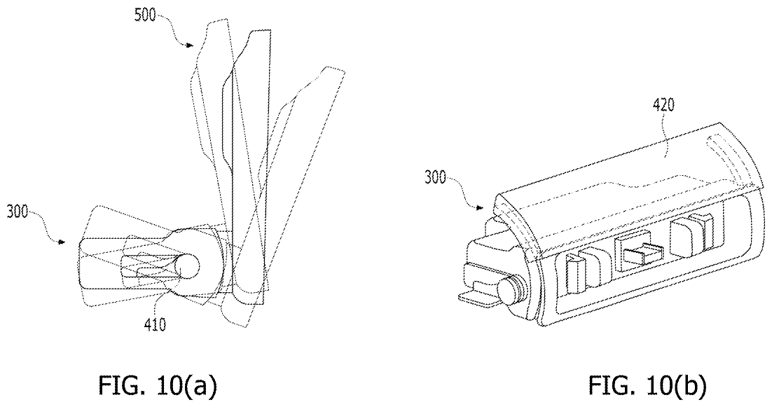

FIG. 10(a) and FIG. 10(b) are a view illustrating a tilting part and a sliding cover in the display device interlocking device according to one embodiment of the present disclosure.

Referring to FIG. 10(a), in the display device interlocking device 300 according to one embodiment of the present disclosure, the mount 310 may include a tilting part 410 arranged to rotate the mount 310 about an axis line oriented in a horizontal direction. The tilting part 410 allows the display device 500 to be rotated to an angle desired by an occupant in the vehicle 100 with the display device 500 coupled to the mount 310. As described above, the display device 500 is likely to be used inside the vehicle 100 as autonomous driving technologies become more advanced and popular. Thus, the tilting part 410 may allow the occupant to use the display device 500 in a more comfortable position inside the vehicle 100.

Referring to FIG. 10(b), in the display device interlocking device 300 according to one embodiment of the present disclosure, the mount 310 may include a sliding cover 420 arranged to open and close the front thereof. When the display device 500 is not coupled to the mount 310, the sliding cover 420 may be closed, which may prevent unnecessary wastage of load space inside the vehicle 100 and may prevent foreign substances, such as dust or beverages, from being introduced into the mount 310.

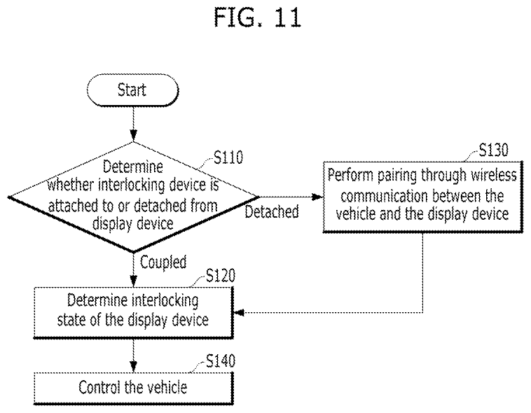

FIG. 11 is a diagram illustrating the display device interlocking method according to one embodiment of the present disclosure.

First, it may be determined whether the display device interlocking device and the display device disposed in the vehicle are attached or detached (S110). When the display device interlocking device and the display device are coupled, the interlocking state of the display device may be determined (S120).

Here, determining the interlocking state of the display device may include determining whether the display device is interlocked with the processor of the vehicle when the display device interlocking device and the display device are coupled.

When the display device interlocking device and the display device are detached, pairing may be performed through wireless communication between the vehicle and the display device (S130). After pairing, the interlocking state of the display device may be determined again (S120), and the vehicle may be controlled based on the attachment or detachment of the display device and the interlocking state of the display device (S140).

In other words, in the display device interlocking method according to one embodiment of the present disclosure, the vehicle may be controlled through the display device by performing pairing through wireless communication, not only when the display device interlocking device and the display device are coupled, but also when the display device interlocking device and the display device are detached.

Here, controlling the vehicle may include controlling a system inside the vehicle, including, for example, operating a heater or air conditioning system of the vehicle, operating a steering wheel, and adjusting the volume of an in-vehicle audio system.

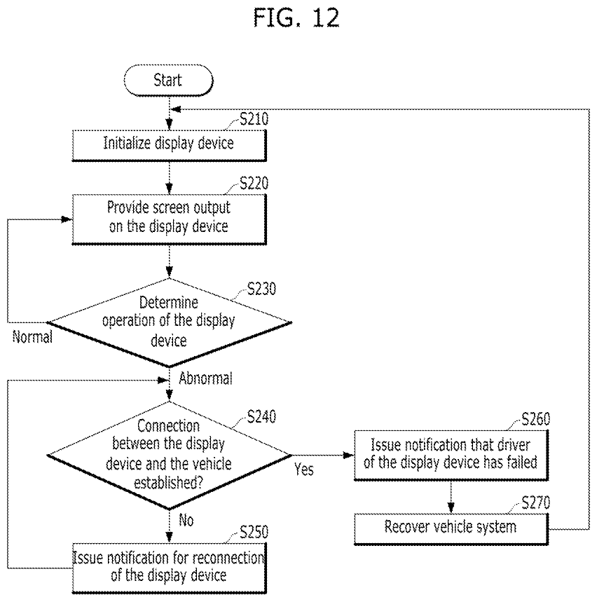

FIG. 12 is a diagram illustrating a display device interlocking method according to another embodiment of the present disclosure.

In the display device interlocking method of the present disclosure, a display device may first be initialized (S210). After initializing the display device, a screen output of the display device may be provided (S220) and the operation of the display device may be determined (S230).

When the display device is operating normally, the screen output of the display device may be continued. However, when the display device is not operating normally, the connection between the display device and the vehicle may be checked (S240).

When the connection between the display device and the vehicle is not properly established, a notification for reconnecting the display device may be issued (S250). In other words, it may be output that the display device and the display device interlocking device have not been coupled or that pairing through wireless communication between the vehicle and the display device has not been established. The notification may be output through an output module of the vehicle or an output module of the display device.

Again, when the display device is not operating normally, but the connection between the display device and the vehicle is properly established, it may be notified that the display driver is malfunctioning and has failed (S260). This notification may also be output through the output module of the vehicle or the output module of the display device. Then, the system of the vehicle may be recovered (S270) and the display device may be initialized again.

Thus, with the display device interlocking device and method of the present disclosure, a vehicle may be controlled by coupling a display device to the interlocking device disposed in the vehicle.

Furthermore, with the display device interlocking device and method of the present disclosure, the vehicle may be controlled by pairing through wireless communication between the vehicle and the display device even when the display device is not coupled to the vehicle.

The foregoing detailed description is not to be construed as limiting in any aspect and should be considered exemplary. The scope of this disclosure shall be determined by a reasonable interpretation of the appended claims, and all changes within the equivalents of the disclosure are within the scope of the present disclosure.

What is claimed is:

1. A device for interlocking a display device with a vehicle, the device comprising:
a mount disposed in the vehicle, the display device being attached to and detached from the mount;
a first sliding member disposed on a front surface of the mount and capable of moving forward or backward in a direction perpendicular to a rear surface of the display device; and
a connector provided to the first sliding member,
wherein the connector transmits and receives electrical signals to and from the display device.

2. The device of claim 1, wherein the display device comprises:
a display module disposed on a front surface thereof and configured to output an image; and
a linkage disposed on a rear surface of the display module and connected to the connector.

3. The device of claim 1, wherein the connector comprises a FAKRA connector.

4. The device of claim 1, wherein the mount comprises: a second sliding member disposed to move the first sliding member.

5. The device of claim 4, wherein the first sliding member and the second sliding member comprise:
racks arranged on lateral surfaces thereof; and
a pinion engaged with the racks to move the first sliding member and the second sliding member in opposite directions.

6. The device of claim 4, wherein the second sliding member comprises:
a first elastic member arranged to exert an elastic force when the display device is attached to and detached from the mount.

7. The device of claim 4, wherein the display device comprises: a coupling part disposed on a rear surface thereof,
wherein the coupling part comprises a first fastener having a first engagement protrusion,
wherein the first fastener comprises a second fastener disposed on a side of the second sliding member and having a second engagement protrusion.

8. The device of claim 7, wherein the first fastener comprises: a seating groove, the second engagement protrusion being seated in the seating groove.

9. The device of claim 7, wherein the coupling part seating groove comprises:
a rotating arm configured to move the first fastener in a horizontal direction parallel to the rear surface of the display device.

10. The device of claim 9, wherein the coupling part comprises:
a third sliding member disposed to move in a vertical direction parallel to the rear surface of the display device,
wherein the third sliding member is coupled to the rotating arm to rotate the rotating arm.

11. The device of claim 10, wherein the first fastener comprises:
a second elastic member arranged to exert an elastic force upon rotation of the rotating arm.

12. The display device of claim 10, wherein the third sliding member comprises:
a handle protruding toward the rear surface of the display device,
wherein the coupling part further comprises:
a handle hole formed to expose the handle to and outside and secure a movement region for the handle.

13. The device of claim 4, wherein the mount comprises:
a first switch disposed in a movement region of the first sliding member; and
a second switch disposed in a movement region of the second sliding member,
wherein the first switch and the second switch detect whether the display device is attached to or detached from the mount.

14. The device of claim 1, wherein the mount comprises:
a tilting part arranged to rotate the mount about an axis line oriented in a horizontal direction.

15. The device of claim 1, wherein the mount comprises:
a sliding cover arranged to open and close a front of the mount.

16. A method of interlocking a display device with a vehicle, the method comprising:
determining whether the display device is attached to or detached from a display device interlocking device disposed in the vehicle;
determining an interlocking state of the display device; and
controlling the vehicle in response to the determination whether the display device is attached or detached and the interlocking state of the display device.

17. The method of claim 16, wherein the determining the interlocking state of the display device comprises:
determining whether the display device is interlocked with a processor of the vehicle in response to a determination that the display device is attached to the display device interlocking device.

18. The method of claim 16, wherein the determining the interlocking state of the display device comprises:
determining whether the display device is interlocked with a processor of the vehicle in response to a determination that the display device is detached from the display device interlocking device.

19. The method of claim 18, further comprising:
performing pairing through wireless communication between the vehicle and the display device.

20. The method of claim 16, wherein the determining the interlocking state of the display device comprises:
outputting the interlocking state to an output module of the vehicle or an output module of the display device.
